(19) United States
(12) Patent Application Publication
(10) Pub. No.: US 2004/0111968 A1
(43) Pub. Date: Jun. 17, 2004

(54) Production and use of a soil amendment made by the combined production of hydrogen, sequestered carbon and utilizing off gases containing carbon dioxide

(76) Inventors: Danny Marshal Day, Atlanta, GA (US); James Weifu Lee, Knoxville, TN (US)

Correspondence Address: W. Scott Petty, Esq., KING & SPALDING LLP, 45th Floor, 191 Peachtree Street, N.E., Atlanta, GA, 30303, US

(21) Appl. No.: 10/690,838

(22) Filed: Oct. 22, 2003

Related U.S. Application Data
(60) Provisional application No. 60/420,766, filed on Oct. 22, 2002.

(51) Int. Cl. C01B 31/02; C10B 57/04; C10B 51/00; C10J 1/00

(52) U.S. Cl. 48/197 FM; 423/445 R; 201/25; 585/241; 48/197 R

(57) ABSTRACT

This invention relates a series of steps to provide an economical production of a carbon based fertilizer and soil amendment made during the capture of greenhouse gases from the combustion of fossil and non fossil fuels. The invention uses biomass and other carbonaceous sources through pyrolytic conversion to gases and charcoal, to allow for the further production of co-products, such as hydrogen and ammonia. The invention also relates to the combination of hydrated ammonia, combustion flue gas exhaust, and charcoal, provide for the conversion of the charcoal into a valued added soil amendment to return essential trace minerals and plant nutrients to the soil. The ability to produce a large volume carbon co-product while removing mandated emissions and producing renewable based hydrogen provides an economic gain to a large number small and large businesses and increase the chance of achieving significant reductions in greenhouse gas emissions.

### CROSS REFERENCE TO RELATED APPLICATION

Applicants hereby claim the benefit under 35 U.S.C. Sec. 119(e) of the U.S. Provisional Patent Application No. 60/420,766, filed Oct. 22, 2002, entitled “The Production and Use of a Soil Amendment made by the Combined Production of Hydrogen, Sequestered Carbon and utilizing Off Gases Containing Carbon Dioxide”, which is fully incorporated herein by reference.

### FIELD OF THE INVENTION

This invention relates to the production and use of a nitrogen enriched carbon based fertilizer and soil amendment made during the pyrolytic conversion of carbonaceous materials which produce charcoal and the reaction of said charcoal with ammonia, carbon dioxide, water and other components generally found in flue gas emissions. The invention also relates to the optimization of that charcoal with mineral and plant nutrients to produce and use the combined materials as a soil amendment and fertilizer. The invention also relates to the use of the material as a way to economically store carbon and captured greenhouse gases in the soil.

### BACKGROUND OF THE INVENTION

The increasing anthropogenic CO₂ emissions and possible global warming have challenged the United States and other countries to find new and better ways to meet the world's increasing needs for energy while, at the same time, reducing greenhouse gas emissions. Recent evidence has shown that melting glaciers, freshwater influxes into the oceans and thinning ice at the North Pole are likely the result on the earth's warming. The National Acadamy of Sciences report in 2002, on Rapid Climate Change, has detailed evidence that changes in the earth's climate has occurred very rapidly in the past. Due to the mounting evidence of global warming, nations have wisely sought to work together to reduce potential impacts of greenhouse gas emissions through negotiated agreements, most notably the Kyoto Agreement. The agreement, signed currently by a majority of the planet's nation states, seek to limit greenhouse gas emissions at 1990 levels. However, many are calling for greater reductions. On Feb. 24, 2003, Prime Minister Tony Blair, one of the United States closest allies, said in a speech, “It is clear Kyoto is not radical enough.” and “We know now, from further research and evidence, that to stop further damage to the climate we need a 60% reduction world-wide”. This number represents trillions of dollars in goods, services and electrons created through those emissions by businesses that perceive risk and loss of income of such reductions. However, evidence is mounting that a path does need to be implemented quickly and the quickest way to implement a portion of the global solution is to develop commercial and environmental synergies that reduce risk and potential losses. Solutions that stabilize income potential for the world's business community, establish sustainable methods of growing food, and help meet the energy demands of the economically developing societies will meet far less resistance than solutions with little corresponding value other than sequestration.

The challenge humanity faces is how to significantly reduce of our non-renewable greenhouse gas emissions. The use of reforestation is one solution, but that is limited as forest and biomass utilize available soil nutrients, primarily nitrogen.

William Schlesinger, Dean of the Nicholas School of the Environment and Earth Sciences at Duke University noted in 2001;

“However, the rate of carbon storage in forests declines as they mature, so the only way by which reforestation programs can continue to sequester carbon over the long term is if they transition into programs that produce commercial biomass fuels; that is, we must replace fossil fuel with biomass energy. It would require reforestation of all the once-forested land on Earth, including that now used for agriculture or covered by urban areas, to store 6 PgC/yr—the amount emitted each year from fossil fuel combustion” (Vitousek 1991).

In order to meet these increasing demands, methods have been proposed and are being researched to sequester carbon in the ocean through fertilization and carbon dioxide uptake (U.S. Pat. No. 6,200,530) and through pumping of CO2 into the ocean (U.S. Pat. No. 6,598,407). Other methods, such as injection in coal seams or underground reservoirs are also being researched heavily. All these methods represent an expense except in specific areas where CO2 can be used for enhanced oil recovery.

Many methods have been developed for removing other greenhouse gases and air pollutants such as of nitrogen and sulfur oxides from flue gas exhaust of fossil fuels. Some of these processes result in a byproduct fertilizer, which create a profit center through utilization of the materials. For background purposes, some related patents that support this approach are discussed here. U.S. Pat. No. 5,624,649, teaches a method for producing potassium sulfate while removing sulfur dioxide from flue gas. U.S. Pat. No. 6,605,263, describes methods for producing ammonium sulfate during the same. U.S. Pat. No. 4,540,554, describes the use of potassium compounds to produce potash fertilizer while scrubbing for sulfur oxides and nitrogen oxides. U.S. Pat. No. 4,028,087, describes the production of a fertilizer from baghouse sludge-ammonia-acid salts. U.S. Pat. No. 5,695,616, teaches the production of ammonium sulfate and ammonium nitrate via the use of a electron beam and ammonia. In U.S. Pat. No. 6,363,869, potassium hydroxide is to produce potassium nitrate and potassium sulfate from flue gas.

The capture of sulfur and nitrogen gases and their conversion into fertilizers does help. They create potent greenhouse gases however it is small in comparison to the impact of carbon dioxide. However, as a fertilizer, they can increase plant growth and help increase natural sequestration. The volume of carbon that has grown and is growing in the atmosphere means the most direct path is to directly reduce the size of our carbon dioxide pool by capturing and utilizing carbon and carbon compounds in long life applications. Capturing carbon while creating a value added carbon based fertilizer/soil amendment would help solve the problems related to biomass sequestration. It can help restore nutrients that have been removed through aggressive harvesting and provide plants with essential nutrients that allow them to utilize the higher levels of CO2 in our atmosphere. It is also one of the few existing distribution channel (i.e. the farm/agrochemical industry), which is paid to move millions of tons of natural and synthetic compounds to farms worldwide. However, the most rapid adoption comes with profits and income. Therefore, this solution should yield more food, fiber, and energy than we currently are able to achieve, and it should do it in a way that could be sustained for thousands of years without degrading the environment.

Traditional agricultural practices such as land clearing and cultivation of soil have led to land degradation, mineralization of soil organic carbon (SOC) and the subsequent loss of SOC as carbon dioxide (CO2) emitted to the atmosphere (Lal et al, 1998; Hao et al., 2001). These activities have reduced soil's natural ability to grow plant life in abundance. Additionally, the depletion of trace minerals from our soils are impacting the health of our ecosphere and risk creating mankind as a species depending on a smaller and smaller window of elements to support a growing world population. This reduction in elemental diversity could have long term effects on the future health and development of our species.

The use of carbon-based fertilizers to effect long-term storage of the carbon and remove atmospheric carbon dioxide requires that the carbon must be stable and or convert in the soil to a stable material. The earth has a carbon that meets these requirements. That carbon is charcoal. Charcoal makes up a significant percentage of our soil. In five representative soil samples, USDA soil scientist Don Reicosky, reported that up to 35% of soil carbon was comprised of charcoal. What is exciting is that not only is charcoal found in soils in great abundance but also that it provides substantial value once there.

Reports of historical use of charcoal as a soil amendment date back over 2000 years to the Amazon rain forest. (Glaser, 1999) Man-made sites, known as “Terra Preta” (black dirt) have been purported to be created by an indigenous people who were able to overcome poor quality soils by adding charcoal. These sites, with their broken pottery and other indicators of human occupation, after a thousand years sites are valued today because they out produce non-manmade soils by 3 fold (Mann, 2002). The ability to increase crop yields does not just apply to old charcoal. Steiner, (unpublished) recreated Terra Preta soils in Brazil with fresh charcoal from a local supplier and reported up 280% increases in biomass yields over fertilization alone. His crop yields were even higher. Glaser (1999) reports 17% increase in rice yields with charcoal additions over a control. Hoshi reports 20-40% increase in plant height and volume with the addition of bamboo charcoal over controls with an optimum at 100 g per square meter per year (or 1 ton per hectare or 890 lbs/acre). Nishio in studies using commercial charcoal made from bark, found alfalfa growth increases of 1.7-1.9 times over fertilization alone.

Relation between charcoal amendments to soil and crop response

| | | Biomass | | |
|---|---|---|---|---|
| | Amendment | production | | |
| Treatment | (Mg ha-1) | (%) | Plant type | Soil type |
| Control | — | 100 | Pea | Dehli soil |
| Charcoal | 0.5 | 160 | Pea | Dehli soil |
| Control | — | 100 | Moong | Dehli soil |
| Charcoal | 0.5 | 122 | Moong | Dehli soil |
| Control | — | 100 | Cowpea | Xanthic Ferralsol |
| Charcoal | 33.6 | 127 | Oats | Sand |
| Charcoal | 67.2 | 120 | Rice | Xanthic Ferralsol |
| Charcoal | 67.2 | 150 | Cowpea | Xanthic Ferralsol |
| Charcoal | 135.2 | 200 | Cowpea | Xanthic Ferralsol |
| Control | — | 100 | Sugi trees | Clay loam |
| Wood charcoal | 0.5 | 249 | Sugi trees | Clay loam |
| Bark charcoal | 0.5 | 324 | Sugi trees | Clay loam |
| Activated | 0.5 | 244 | Sugi trees | Clay loam |
| charcoal | | | | |

Charcoal is a form of sequestered carbon that will not rapidly decompose and return CO₂ into the atmosphere. It is very resistant to microbial decay. (Glaser 1999; Glaser et al. 2001a). Studies have shown that Terra Preta soils contained up to 70 times more pyrogenic C (charcoal) than the surrounding soils. The hypothesis is that charcoal persists in the soil for centuries due to its chemical stability caused by the aromatic structure. (Glaser, el al. 2002) The material's chemical structure is resistant to microbial degradation (Goldberg 1985; Schmidt et al. 1999; Seiler and Crutzen 1980). Glaser confirmed the stability by 14C dating of the soil charcoal with results showing ages of 1,000-2,000 years.(Glaser et al. 2000).Other reports show that charcoal can even be found in highly weathered environments with carbon dating it back thousands of years. (Gavin, 2002; Saldarriaga et al.1986).

Charcoal has unique physical structures and chemical properties, which if optimized, offer significant value as a soil amendment. Its open porous structure readily adsorbs many naturally occurring compounds. This property allows charcoal to act as a natural sponge. In crop farming, applied nutrients are rapidly leached below the root zone of annual crops (Cahn et al., 1993; Melgar et al., 1992) however, charcoal can adsorb and hold nutrients at the root level of plants and reduce leaching. (Lehmann, 2000). Charcoal also acts to increase soil's water holding capacity and increase cation exchange capacity. (Glaser, 1999). Evidence in the Terra Preta soils show that these traits do not diminish significantly with time and therefore new exchange sites are being created, however slowly. Charcoal does breakdown through abiotic oxidation of elemental C to CO 2, however, under environmental conditions, this process is extremely slow (Shneour 1966). It is known that can fungi and bacteria are capable of de-grading low-rank coals such as brown coal (Fakoussa and Hofrichter 1999). It has been shown (Hofrichter et al. 1999) that extracellular manganese peroxidase is an enzyme of wood-rotting and leaflitter-decaying basidiomycetes capable of degrading macromolecular fractions of brown coal (lignite). As a result of such decay, reactive products such as phenoxy, peroxyl and C-centred radicals are formed which subsequently undergo non-enzymatic reactions leading to the cleavage of covalent bonds, including the fission of aromatic rings. (Glaser,et al.2002)

Charcoal has the potential to form organo-mineral complexes (Ma et al. 1979), which are found in Terra Preta soils (Glaser et al. 2000). The assumption is that slow oxidation (biotic and/or abiotic) on the edges of the aromatic backbone of charcoal forming carboxylic groups is responsible for both the potential of forming organo-mineral complexes and the sustainable increase in CEC (Glaser 1999; Glaser et al. 2000, 2001a). From the stand point of carbon sequestration, this means that it is not a permanent removal but from the vantage point of a soil amendment, it has value now and will continue to add value to soils just as the charcoal added to the Terra Preta soils have done for the last few thousand years.

The open pore structure can provide safe haven from faunal predators for essential symbiotic microbial communities (Pietkien, Zackrisson et al. (1996),. In her research she investigated microbial communities that would repopulate the ground after a forest fire. In the experiment she prepared four adorbents, pumice (Pum), activated carbon (ActC), charcoal from Empetrum nigrum twigs (EmpCh) , and charcoal* from humus (HuCh) (*pyrolyzed at 450C). A 25 gram microcosm of untreated humus was covered by 25 grams of the above adsorbents and moistened regularly with litter extract that contained 170 mg l⁻¹ glucose, which was included in the total concentration of organic C (730 mg l⁻¹). The adsorbents bound organic compounds with different affinities; the adsorbing capacity increased in the order: Pum<HuCh<EmpCh<ActC. After the one-month incubation, the size of the microbial biomass in the adsorbents followed the order EmpCh>HuCh>ActC>Pum (V, FIG. 1). Activity, measured as basal respiration and rate of bacterial growth rate, were higher in both EmpCh, HuCh than in ActC or Pum. In her analysis, she observes that microbes attached themselves to the charcoal particles and preferentially degraded the adsorbed substrates as with biological activated carbon beds (De Laat et al. 1985, Kim et al. 1997). She concluded that charcoal formed by combustion when moistened with substrate-rich litter extract was capable of supporting microbial communities.

The importance of soil fertility and the need for thriving symbiotic microbial communities cannot be understated. While we do not understand their functions, the millions of species of fungi, bacteria and other microbiota represent over 15% of all species on the earth. From their roles nitrogen fixing to providing plant defenses, the life below ground represents an ecosystem with thousands to hundreds of thousands of interacting species. (Hanksworth et al, 1992; (Trüper 1992). The development of a carbon based fertilizer should have aspects that facilitate soil microbe activity. In the production of charcoal, volatile organic species are evolved during the rise in temperature. From 280C to 450C this exothermic process can continue in an oxygen starved environment as is well known to those skilled in charcoal production. These gases (Runkel and Wilke, 1951) as the move through the carbonizing material, are distilled with other molecules forming both shorter and longer chain molecules. Longer chain molecules have higher dew points. These new compounds then condense to form intraparticle condensates. The continued rise in temperature during the exothermic phase, repeats this process many times before vapor phase molecules leave the char particle. Under increased pressure and subsequent high dew points, these compounds will remain as additional char (U.S. Pat. No. 5,551,958). Evidence that the condensates provide a source of nutrients for microbial activity from charcoal pyrolysis were demonstrated by the US Geological Survey (Michel, 1999). At temperatures below the highest due point, specific compounds will necessarily condense. To drive off these remaining molecules require higher temperatures, as is well known to those who make activated carbons, and when charcoal is halted at lower temperatures, these compounds remain. This evidence supports the results from Pitikein that charred wood perform better as a host site for microbial communities due to the incomplete combustion and available sources of nutrients. There may also be other factors also present which are currently unknown.

It is well know to those skilled in the art of pyrolysis that above 425C, that the pipes and reactors remain clear of tar deposits. By removing char from its heated environment at close proximity to this number we can allow a certain amounts of volatile organics to remain in the char while still converting the material into a stable form of carbon. The majority will convert into polynuclear aromatic and heteroaromatic ring systems as structural units. These have been shown to provide charcoals with chemical and microbiological resistance (Haumaier and Zech 1995; Glaser et al.1998), but not total immunity.

Limited work has been published on optimizing charcoal production for use as a soil amendment. Glaser, Lehmann and Zech's work in Biology and Fertility of Soils, 2002; 35:219-230 present an excellent review of published material. This work reviews the evidence and past work in studying charcoal production and impact as a soil amendment. The Food and Fertilizer Technology Center for the Asian and Pacific Region instructs in a leaflet for farmers on the use of charcoal that they can experience 10-40% increases and show research results of 138% increases with charcoal plus fertilizer over fertilization alone. The leaflet instructs methods of making rice hull char in an above ground mound charring system. Instructions were limited to charring the material until it was “smoked black” and to not let it turn to ash.

The use of charcoal and activated carbon for fertilizers and soil amendments is well known and has been referenced by U.S. Pat. No. 2,684,295, U.S. Pat. No. 4,529,434, U.S. Pat. No. 4,670,039, U.S. Pat. No. 5,127,187, U.S. Pat. No. 522,561, U.S. Pat. No. 5,921,024, YS 6273927, and U.S. Pat. No. 6,302,396. Each of these teach that charcoal or activated carbon is a fertilizer component but do not instruct on its manufacture or optimization for this purpose.

Other patents give more details. U.S. Pat. No. 3,259,501 teaches the use of an ammoniated and charred rice hulls for fertilizer and U.S. Pat. No. 2,171,408 teaches the use of sulfuric acid activated carbons for fertilizer due to high ion exchange capacity. No instruction is given on the manufacture of the charcoal. U.S. Pat. No. 3,146,087 describes a process for preparing a fertilizer containing water-insoluble nitrogen from wood utilizing high pressure and long duration times, however it offers no carbon capture instruction or optimization.

BR 409658 instructs on using charcoal with phosphoric acid, potassium nitrate and ammonia but again no instruction of carbon capture.

BR 422061 teaches that acid groups created in charcoal by chlorine treatment allow adsorption of nitrogen compounds allowing up to 20% available nitrogen. However, the inventor does not relay that this can be developed by a state within a temperature profile of carbonization. He does offer that a gas treatment of chlorine on a moistened carbonized materials and a treatment on the same by ammonia gas or aqueous ammonia followed by blown air will produce a good ammonium bicarbonate fertilizer but gives no reference to CO2 or capture mechanism to achieve this product.

This corresponds to research (Assada et.al, 2002) which showed that lower temperature charcoal produced at 500C adsorbed 95% of ammonia versus charcoal produced at 700C and 1000C which had higher surface areas but only adsorbed 40%. The study noted that acidic functional groups such as carboxyl were formed from lignin and cellulose at 400-500C. (Matsui, et al. 2000; Nishimya, et. al, 1998). It concludes that charcoals, regardless of source, that form acidic functional groups at these temperatures will preferentially adsorb base compounds such as ammonia and that the chemical adsorption plays the primary role over surface area. This research points to a key ingredient in optimizing a charcoal to act as a nutrient carrier; carbonization conditions.

U.S. Pat. No. 5,676,727 teaches a method for producing slow-release nitrogenous organic fertilizer from biomass. In this process, pyrolysis products obtained from the pyrolysis of biomass use a chemical reaction to combine a nitrogen compound containing the —NH.sub.2 group with the pyrolysis products to form a mixture. The process is included for reference but does not mention CO2 sequestration nor the ability to utilize the process for flue gas cleanup.

U.S. Pat. No. 5,587,136 instructs on the use of a carbonaceous adsorbent with ammonia in the process of sulfur and nitrogen flue gas removal. Reference is made to it being an active coke but no instructions were provided in its manufacture and no reference to carbon dioxide removal.

U.S. Pat. No. 5,630,367, provides instructions on converting tires into activated carbons for use as a fertilizer. It instructs using a combustion process with a temperature of 400 to 900 C and preferably 700-800C with air, CO2 and water vapor. While no specifics are given of yields, the process does detail removal of ash, therefore the temperature of the char is likely to higher than 700 and most of the tire will have been converted to carbon dioxide. The designation of the material as a good carrier for nutrients due to its high cation exchange capacity is a reasonable assumption on the surface but as was shown by (Tryon1948) cation exchange should be converted to cation availability because the sum of the determined cations in charcoal exceeded the CEC by a factor of about 3. Glaser explains that cations in the ash contained in the charcoal were not bound by electrostatic forces but present as dissolvable salts and, therefore, readily available for plant up-take. This increase in “exchangeable” cations, leads to the determination that charcoal CEC measurement is but one component. The mineral ash percentage contained and now concentrated in the charcoal, allow the charcoal to act as a fertilizer itself. Indeed, our microscopic studies of growth in plants in charcoal reveal that root hairs envelope and extend into char particles, probably working in harmony with symbiotic microbiotic communities to extract these nutrients. It is not explained to what extent tire char particles liberated during combustion have trace minerals, however the advantage of returning trace minerals back to the soil from which they were remove via harvest is an important trait of charcoal based fertilizers. The above patent offers that the material may be used as an adsorbent in sulfur and nitrogen flue gas removal however there was no methodology offered as to its use or any particular advantage to the material for this purpose.

U.S. Pat. No. 5,061,467 teaches dry methods from scrubbing sulfur dioxide. Activated charcoal is mentioned but no mention is made to optimize char for ammonia adsorption or for developing its value as a fertilizer co-product. Gypsum is the only co-product mentioned.

U.S. Pat. No. 6,405,664 instructs on using ammonia liberated from decomposing organic materials. Fly ash to be mixed with dried organics residues as a soil amendment or additional fuel but the incorporation of dried waste with ammonia is not mentioned.

U.S. Pat. No. 5,587,136, teaches the use of ammonia with a carbon adsorbent but does specify the use for CO2 removal. Furthermore, the temperature ranges selected will not support any substantive formation of a carbon based fertilizer and concentrations of ammonia added would not yield conversion percentages needed for this application. The instruction is for choosing a carbon black, which have different physical properties than charcoal and no information is taught on its development or use as a fertilizer.

U.S. Pat. No. 6,439,138, teaches that charcoal is shown to capture mercury and heavy organics. No reference is made to utilizing char for capture of CO2 and the invention teaches that char is preferably formed at 1200F (648C) to 1500 F (815C). Given the small particle size 10,000 microns to 1,000 microns, the temperature at this size will not optimally produce a material for ammonia adsorption and nor will increase the materials effectiveness as a fertilizer and thus could represent a disposal issue.

U.S. Pat. No. 6,224,839, offers extensive reference to the role played on the adsorption of NOx by carbon in the presence of alkali and alkaline earth metals. This work is incorporated here by reference. The invention discloses the value of char as an adsorbent but offers that the adsorption falls off as sites are filled. No attempt was made to show carbon being replaced as sites were filled, nor to create a value added compound. Instead, the intent was to recycle carbons rather than process them into a fertilizer.

In U.S. Pat. No. 6,599,118, pyrolysis gasses are added to the combustion gases to remove NOx but the char is burned and no fertilizer is produced. U.S. Pat. No. 4,915,921 teaches the capability of using a coal based activated carbon with ammonia injection for the removal of sulfur oxides and nitrogen oxides at 100-180C but not carbon dioxide. The carbon was not assumed it would be used as a fertilizer, nor was it optimized.

U.S. Pat. No. 5,584,905, teaches the use household garbage to convert flue gas emissions into a fertilizer. His effort should be admired as he taught ways to increase the materials value as a fertilizer. His teaches that of ammonia derived from decomposing meats, proteins and fatty acids found in household garbage combining with carbon dioxide to sulfur dioxide to form ammonium fertilizers. While one could envision such a system, the commercial practicality and potential difficulties in gaining environmental permits would prove difficult. He does not teach the use of char nor the direct use of added ammonia in such a system.

In almost all prior inventions, the amounts of fertilizer generated was so small that the focus has been exclusively of the scrubbing performance. However, a conceptual framework of seeking to increase a sequestering co-product's value while still conducting essential emissions removal including carbon dioxide has not been demonstrated.

### SUMMARY OF THE INVENTION

It is therefore an object of this present invention to provide an effective soil amendment containing a source of nitrogen or may also include one or more of soil nutrients. Additionally, this material will have properties that provide long term benefit to the user by increasing cation exchange, increasing water holding

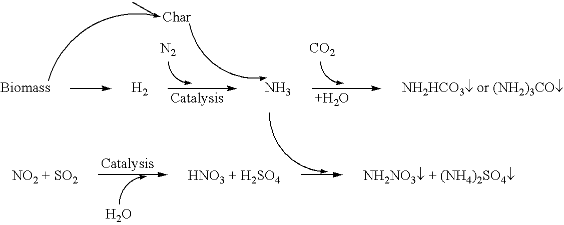

capacity for course soils, decreasing nutrient leaching rates, increasing the soil carbon content and a majority of its dry weight represents sequestered carbon. Another object is that this material be made during the capture of a CO2 stream or during the capture process of CO2 with one or more of the naturally occurring elements and compounds, sulfur oxides, nitrous oxides, mercury, lead and/or heavy metals. A further objective is that a charcoal from the pyrolysis, gasification, and/or partial oxidation of biomass and other carbonaceous materials be produced under conditions of this patent and providing for enhanced ability to adsorb ammonia, and decrease nutrient leaching rates. The invention also the object of reducing CO2 emissions cost of producing the fertilizer and includes the option of utilizing the pyrolysis gas to either be used to produce power, or to be converted to hydrogen and then into ammonia thereby enhancing the total carbon sequestered by the system. U.S. Pat. No. 6,447,437 B1 provides the path to sequester carbon by scrubbing off gases of power plants and other sources of carbon dioxide with ammonia to produce ammonium bicarbonate or urea. This invention is an improvement in that it takes the production of these carbon-nitrogen compounds and creates them inside the carbon char structure and leverages the total amount of sequestered carbon by a factor of 3 to 8 times.

### BRIEF DESCRIPTION OF THE DRAWINGS

FIG. 1 shows a method for production of renewable hydrogen and its use in ammonia production, scrubbing and fertilizer production process in accordance with an exemplary embodiment of the present invention.

FIG. 2 illustrates the design of a simple conversion cyclone system where ammonia is utilized for scrubbing a simulated flue gas component producing a sequestering fertilizer in accordance with an exemplary embodiment of the present invention.

FIG. 3 provides an illustration of a design to remove CO₂ emissions in industrial combustion facilities such as a coal-fired power plant by flexible combinations of the synergic processes, the pyrolysis of biomass and or carbonaceous materials and ammonia scrubbing in accordance with an exemplary embodiment of the present invention.

FIG. 4 provides an illustration representing the environmental, societal and technical benefits derived from using CO₂ emissions with the carbon capture into fertilizer and the production of renewable energy in accordance with an exemplary embodiment of the present invention.

### DETAILED DESCRIPTION OF THE EXEMPLARY EMBODIMENTS

The pyrolysis of biomass materials and the steam reforming of the off gases and/or pyrolysis liquids produce significant amounts of hydrogen and a solid char product. Hydrogen, after separation, can be converted into ammonia using the industry standard Haber-Bosch process as the two reactions operate at the same temperature range. The ammonia when combined carbon dioxide (CO₂) form ammonium bicarbonate (NH₄HCO₃), with sulfur dioxide or nitrous oxide and a platinum and nickel catalyst will form HNO₃ and H₂SO₄. These which combined with NH₃ will form as an intermediate of NH₄ HCO₃and (NH₂)₂CO production process, to form additional fertilizer species, (NH₄)NO₃ and (NH₄)₂SO₄. The invention described here is the simultaneous production of hydrogen, its conversion into ammonia, a porous char, the combination of ammonia, and the flue gases of combustion or other high percentage sources of carbon dioxide and the porous char in order to deposition of nitrogen rich compounds in the pore structure of the carbonaceous material. The invention provides the use of this combined porous adsorbent char, enriched with nitrogen compounds, as a slow release fertilizer/soil amendment with also is a novel method for sequestering large amounts of carbon from the atmosphere. Char makes a perfect media for storing significant quantities of compounds. The combination of nitrogen compounds created in and on the carbon can produce a slow release nitrogen fertilizer with many advantages over traditional ammonium nitrate, urea or liquid ammonia. One of these is that it is less reactive reducing the risk of it being used a compound for making explosives.

Since both the bicarbonate HCO₃ of NH₄HCO₃ and the elementary carbon (C) of the char materials are nondigestible to soil bacteria, they can be stored in soil and subsoil earth layers as sequestrated carbons for many years. Therefore, a combined NH₄HCO₃-char product can not only provide nutrients (such as NH₄⁺) for plant growth, but also has the potential to fully utilize the capacity of soil and subsoil earth layers to store both inorganic carbon (such as HCO₃ ) and organic elementary carbon (C). Urea (NH₂)₂CO can also be combined with the char materials to form a similar product. However, the urea production process generally costs some more energy and has less capacity to solidify CO₂ than the CO₂-solidifying NH₄HCO₃ production process (U.S. Pat. No. 6,447,437B1). The char materials are also mixable with other nitrogen fertilizer species such as NH₄NO₃ and (NH₄)SO₄, but those mixtures would not have the benefits of providing bicarbonate (HCO₃) to soils. Therefore, the combined NH₄HCO₃-char product is preferred in realizing the maximal carbon-sequestration potential in soil and subsoil earth layers.

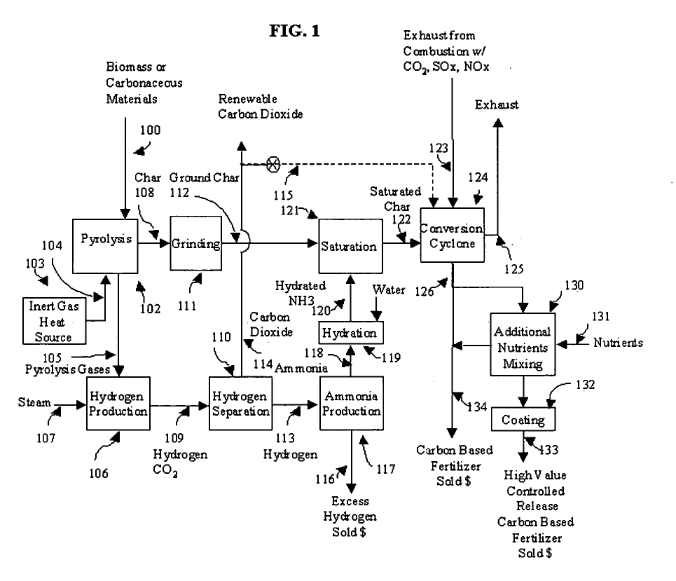

Furthermore, the combined NH₄HCO₃-char product has synergistic benefits. First, the char particles can be used as catalysts (providing more effective nucleation sites) to speed up the formation of solid NH₄HCO₃ particles in the CO₂-solidifying NH₄HCO₃ production process, thus enhancing the efficiency of the CO₂-solidifying technology. Second, the char materials are generally alkaline in pH because of the presence of certain mineral oxides in the ash product. The pH value of a typical char material is about 9.8. This alkaline material may not be favorable for use in alkaline soils such as those in the western United States while it is very suitable for use in acidic soils such as those in the eastern United States. However, use of NH₄HCO₃ can neutralize the alkali of the char materials. When the char materials are mixed with NH₄HCO₃ of equal weight, the pH of the product becomes much better (closer to neutral pH 7). As illustrated in Table 1, the pH value of the NH₄HCO₃-char mixture is 7.89, which is significantly lower (better) than that of the char material (pH 9.85). Therefore, this type of NH₄HCO₃-char combined fertilizer will be able to be used in alkaline soils, in addition to pH neutral and acidic soils. This type of NH₄HCO₃-char fertilizer can be produced either by the char particle-enhanced NH₃-CO₂-solidifying NH₄HCO₃ production process or by physically mixing NH₄HCO₃ with char materials. FIG. 1 presents photograph of the NH₄HCO₃-char fertilizer samples that were created by char particle-enhanced NH₃-CO₂-solidifying NH₄HCO₃ production process [marked as “treated char’] and by a physical mixing of NH₄HCO₃ and char [marked as “NH₄HCO₃-char mixture (50%/50% W)”]. Depending on the amount of NH₄HCO₃ deposited onto the char particles by char particle-enhanced NH₃—CO₂-solidifying NH₄HCO₃ production process, the treated char has a pH value of 8.76 in this particular sample. The pH of the product can be further improved by deposition more NH₄HCO₃ onto the char particles by the process.

When the NH₄HCO₃-char product is applied into soil, it can generate another synergistic benefit. For example, in the western parts of China and the United States China where the soils contains significantly higher amount of alkaline earth minerals and where the soil pH value is generally above 8, when NH₄HCO₃ is used alone, its HCO₃ can neutralize certain alkaline earth minerals such as [Ca(OH)]⁺ and/or Ca⁺⁺ to form stable carbonated mineral products such as CaCO₃ that can serve as a permanent sequestration of the carbon. As more and more carbonated earth mineral products are formed when NH₄HCO₃ is used repeatedly as fertilizer for tens of years, some of the soils could gradually become hardened. This type of “soil hardening” has been noticed in some of soils in the western part of China where NH₄HCO₃ has been used as a fertilizer for over 30 years. It is also known that this type of soil “hardening” problem could be overcome by application of organic manure including humus. Char is another ideal organic material that can overcome the “soil hardening” problem because of its soft, porous, and absorbent properties. Therefore, co-use of NH₄HCO₃ and char materials together can allow continued formation of carbonated mineral products such as CaCO₃ and/or MgCO₃ to sequester maximal amount of carbons into the soil and subsoil terrains while still maintaining good soil properties for plant growth.

Another embodiment of the invention can be to also add other nutrients to the carbon. The material itself contains trace minerals needed for plant growth. Adding phosphorus, calcium and magnesium can augment performance and with industry standard coatings create a slow release micro nutrient delivery system.

Another embodiment of the invention can include the processing of the carbon to produce very large pore structures. The material can be used as an agent to capture watershed runoff of pesticides, and herbicides. By adding a deposition of various materials (example: gaseous iron oxide), the material can be used to capture such compounds as phosphorus from animal feedlots.

Another embodiment for the invention is to use standard industrial processes well known to those skilled in the arts, to use the hydrogen produced, combined with air and other free nitrogen present in the production process to create the ammonia that will be used as the nitrogen source material.

Based on market demands, these products can be further combined with other fertilizer species such as potassium, magnesium, ammonium sulfate, ammonium nitrate, and micro mineral nutrients such as iron and molybdenum to make more-nutrient-complete compound fertilizers.

### EXAMPLE 1

We produced 5 different chars from peanut shells, at different temperatures (900° C., 600° C., 500° C., 450° C. and 400° C.) in a low oxygen environment. In each case, the samples were brought to the target temperature for 1 minute. The samples were taken up to temperature and then allowed to cool. Next the materials were ground and sieved to a particle size less than 30 US mesh and greater than 45 US mesh and prepared 20.0-gram samples. We mixed an aqueous solution of 48% NH₄NO₃ (ammonium nitrate). Each sample was soaked for 5 minutes and then poured through cone filter paper and allowed to air dry for 24 hours. We then poured rinses of 100 ml of tap water (pH8) through the cone filter. The pH of each resulting rinse was measured showing a decreasing pH commensurate with the leaching rates of each material.

There was very little difference between the samples except for the one prepared at 400° C. After three or four rinses, the materials, which were carbonized at the higher temperatures, would stabilize at the pH 8 of the rinse material (local tap water). The 400° C. char showed very little change and it was only after the 9th rinse that it began to drop a bit faster but even after 12 rinses it still had not stabilized.

TABLE 2

| Carbonization | pH | pH | Rinses |
|---|---|---|---|
| Temp | Intitail | Final | Required |
| 900 C. | 9.4 | 9 | 4 |
| 600 C. | 9.3 | 8.8 | 5 |
| 450 C. | 9.2 | 8.5 | 6 |
| 400 C. | 9.1 | 8.8 | 12 |

The work by Asada on bamboo charcoal demonstrated similar impacts on ammonia adsorption.

### EXAMPLE TWO

While the process can apply to many configurations, this example uses a relatively simple production technique. In this case, we used a mechanical fluidized bed easily adaptable to any gas stream and injected CO₂, and hydrated ammonia. A 250 g charge of 30-45 mesh (0.4 mm-0.6 mm), 400° C. char was fed in at regular intervals varying from 15-30 minutes. A higher rotor speed increased the fluidization and suspended the particles until they became too heavy from the deposition of NH₄HCO₃ to be supported by fluidized gas flows. The longer durations produced significantly larger particles. At 10-15 minutes the particles ranged from 1.0 mm to 2.0 mm and between 20-30 minutes they ranged from 3.0 to 6.00 mm. The interior of the particles were then examined under a scanning electron microscope. Internal pore structure showed significant formations of structures of NH₄HCO₃ at 10-15 minutes. The material produced between 20-30 minutes had completely filled internal pores and cavities.

[image]

Global Potential

This chart shows the number of kg of CO2 per million BTUs of each type fuel. Fossil fuels have a significant carbon cost. Hydrogen used as a fuel with carbon utilization can remove 112 kg of CO2 per GJ of energy used. Current energy use is increasing CO2 by 6.1 Gt/yr (IPCC). Renewable hydrogen with carbon utilization and CO2 capture can provide energy with a negative carbon component. To calculate how much negative energy we would need to use at 112 kg of CO2 captured and utilized per 1GJ, to equal the world's 6.1 gigaton CO2 annual surplus, we divide 6.1Gt/112 kg to yield 54Ej. That is approximately what is reported at the world current annual bioenergy consumption (55EJ-Hall)

[image]

The large majority of increases in CO₂ will come from economically developing countries as their burgeoning entrepreneurial populations industrialize. A sustainable technology needs to be able to scale to meet the growing needs of this large segment of the population. Developing an economical size that offers a profitable platform may require certain minimums and it may be that the lower limit of economical production are larger than typical biomass conversion systems. A 1-2 MW facility could be the lower limit yet there are two factors that are important to note. The first is that the low relative efficiencies required by both the hydrogen separation and the ammonia production may allow a smaller foot print system to be developed using new technologies. Future research efforts in separations technologies and ammonia catalyst could offer developments that lead to systems for even very small farming communities.

The second point is that the total hydrogen is approximately three times the maximum that can be utilized in one facility, so every third facility could be designed to accept the charcoal that is produced by two standalone energy systems. This special facility could process all of its hydrogen and the carbon from two other locations and use existing industrial ammonia manufacturing techniques to create the carbon-fertilizer. If all hydrogen is converted to fertilizer then there is an opportunity to acquire outside CO₂ (34 kg required for each 100 kg biomass processed) and the opportunity to earn revenue from SOx, NOx removal could provide it with another income stream and help its economics. It would also fit closely into strategies of developing areas that wish to attract and support GHG emitting manufacturing.

The energy from a total systems point of view could create a viable pathway to carbon negative energy as detailed in the IIASA focus on Bioenergy Utilization with CO₂ Capture and Sequestration (BECS). The effects shown in the prior graph (FIG. 16) (i.e. providing 112 kg of CO₂ removal for each GJ of energy used) could allow major manufacturers to offset their carbon costs. The graph in FIG. 17 shows various materials used in automobile manufacturing and the life cycle analysis of carbon emissions per kilogram. The second bar in stripes represents the weight of biomass using this process, which would be required to offset that carbon cost. The third bar, extending down in the checked pattern, shows the amount of sequestered carbon that would be created if the process were used to produce all the energy required for production and the last bar represents the amount of biomass required to meet the energy needs of producing that amount of the automotive material. In some materials, the amounts needed for energy production are less than the amounts needed for carbon offset. This illustrates that energy is just one aspect of GHG production related to materials manufacturing and that methods for offsetting CO₂ release are essential.

[image]

The opportunity for economically developing areas with biomass is to utilize their resources to help manufacturers reach carbon-negative status. If the material leaves a factory with a net carbon negative budget, then the behavior of consumerism becomes an agent of climate mitigation and supports economies in side stepping fossil fuel pathways.

How large could this method be applied and to what areas of the earth could utilize a concerted effort to reclaim eroded land and increase current farmland production are areas for future research. The positive impact of an increased soil carbon content ultimately leads to increased food and plant yields, further helping to reduce CO₂ buildup. There is very little information on the maximum rates of utilization, though 10,000 kg/ha of char have been used with very positive results and researchers have proposed that as little as 2000 kg/ha could prove beneficial for plant growth. (Glaser, et al. 2002; ICFAC,2002)

For a quick test of reasonableness, we saw from above that 1GJ of hydrogen produced and used will represent 112 kg of utilized and stored carbon dioxide. Therefore, taking the atmospheric rise of 6.1GT and dividing by 112 kg/Gj=54.5EJ. This number falls amazingly along the 55EJ estimate of the current amount of biomass that is used for energy in the world today.(Hall et al. 1983) While the potential reaches many times this for the future utilization of biomass, this shows that there is a chance that we can be proactive in our approach.

Technical/Economic Overview and Global Impacts

A study of the economics of the ORNL process for NH₄HCO₃ production from fossil fuel scrubbing was conducted by the University of Tennessee (“UT Study”) in 2001. There are also ongoing economic evaluations of renewable hydrogen production from the US National Renewable Energy Laboratory. Those studies can provide the outer framework for this preliminary economic estimate. The UT, examined the economics of producing ammonium bicarbonate in the exhaust stream of fossil fuel combustion. It assumed the use of natural gas to produce ammonia and the subsequent conversion to ammonium bicarbonate. Since this was prior to the use of charcoal inclusion, it did not include any economic gains, which could be attributed to charcoal. Some gains benefit the fossil fuel user. These include a single system for removal of CO₂, SOx and NOx, no required drying of the final product and offsetting income from fertilizer sales. Optimally, fossil fuel users will partner with fertilizer manufacturers to use their existing market penetration. Fertilizer manufacturing firms, which have been relegated to the sale of commodity goods, can reinvent their product offerings to include service-based delivery of soil fertility and management of soil carbon content. Utilizing advances in remote and satellite monitoring technologies and a more in depth local delivery of site specific management techniques, these services will offer a regional advantages which can withstand competition that global commodity chemicals production cannot.

More gains accrue to farmers as these fertilizers can restore soil carbon content, return trace minerals to degraded lands, increase in cation exchange, water holding capacity, microbial activity and decrease in nutrient leaching which all lead to increases in crop yields. Assumptions of these increases and income derived cannot be made until more detailed yield and cost analysis for the amounts of ECOSS utilized, yields of specific crops on representative soils, type of irrigation, and other factors essential to determine farm income. The closed cycle begins with farmers entering into long term contracts to supply energy crops (which can be grown on marginal lands), forestry thinnings and other sources of biomass, which will be required by this soil-food-energy-carbon management value chain. These contracts will help establish revenue sources to support effective land, forest and crop management strategies.

Seeing this from a global perspective, this technique simulates the interdependence we find in among organic species in nature. Each role is essential and rewards are evolved through market mechanisms. This diversity in economic gain offers to help restore the growth opportunities to farming, forestry and small rural businesses. Instead of a transfer of wealth, this is a grass roots development of income, which has been literally going up in smoke for the last two centuries. The development of opportunity and broad based growth in entrepreneurial activity, farm operations and businesses that support them, will lead to more stable and predictable income for multinationals, medium and small businesses and lead to an increase in the rural tax base. While this is not a cure all, it moves the world to more sustainable growth strategies.

The economic projections of the UT study were based on a market value of the end product at $2.63/lb atom of nitrogen based on 1999 prices of nitrogen fertilizer. Today's prices are significantly higher due to increased natural gas prices. However, with a target of 20% CO₂ removal, the study concluded that a 700 MW facility would be optimally sized for the economical production of fertilizer and would yield a after tax ROI of $0.33. The investment required to meet this level of CO₂ capture was calculated to be $229 million. The same amount of carbon captured with ECOSS, where 88% of the target will be met by the carbon contained in the char would only require a production unit one-fifth the size and possibly smaller. Additionally, the system can be much simpler than what was required to convert 100% of hydrogen produced into ammonia. With this approach, the engineering and construction costs can be significantly reduced. While economics and scale of ammonia production typically favor larger installations, Kyoto reduction targets can be met through smaller facilities where the efficiency is in carbon utilization.

The UT study assumed the world's consumption and demand for nitrogen would became the limiting factor in how much carbon could be captured. The total market for nitrogen in 1999 was 80.95 million tons, which then converted at the power plant targeting 20% reductions in CO₂, lead to the determination that 337 fossil fuel plants of 237 MW each would meet world fertilizer demand. Their calculations showed that this would reduce the global C output from coal combustion by 3.15%. The study also assumed the use of natural gas to make the ammonia. The total stoichiometric calculation for ammonia from natural gas and the conversion of 8 lb-moles of NH₃ into NH₄HCO₃, which captures 5 lb moles of CO₂. With renewable hydrogen to make ammonia, no fossil fuel based CO₂ is release into the atmosphere and the following is found,

8NH₃+8CO₂+8H₂0>8NH₄HCO₃.

Therefore, renewable hydrogen allows a 1.6 times increase in CO₂ captured per lb-mole of NH₄HCO₃ produced. Utilizing the study above, a switch to renewable hydrogen would increase carbon capture, 3.15×1.6=5.04%. However, carbon closure of biomass energy is not zero but has been calculated (Spath&Mann-1997) at 95%. A more accurate number would be 5.04×95%=4.79% reduction in C from worldwide coal combustion if renewable H₂ as the source for producing ammonia and all the world's N requirements are met from NH₄HCO₃ scrubbed from power plant exhaust.

As stated before, the total C captured in the combined ECOSS material was 12% from fertilizer and 88% from char. Taking the theoretical number of 4.79% and equating that to the 12% portion of ECOSS, would mean that the total carbon capture at 1999 N levels would be increased or leveraged 100/12=8.3 fold or reduce total C from coal combustion by ˜39.9%. This leveraged total should be seen as a theoretical potential. The factors of increased biomass growth with the addition of charcoal as found by Mann (2002), Hoshi(2002), Glaser(2002), Nishio(1999) and Ogawa(1983) show increase biomass growth from 17% to as 280% with non-optimized char. The direct utilization of an optimized char plus slow release nitrogen/nutrients may allow the increase biomass growth targets worldwide. A portion of this increased biomass growth will be converted to soil organic matter, further increasing C capture (especially if no-till management practices are adopted). Therefore, another bracket in our assessment of this process is the increase in non-fossil fuel CO₂ capture from biomass growth in addition to the leveraged total.

The ability to slow down the release of ammonia in the soil will allow plants to increase their uptake of nitrogen. This will lead to a reduction in NO₂ atmospheric release. This potent greenhouse gas is equivalent to 310× the impact of CO₂. The fertilizer industry releases CO₂ during the manufacture of ammonia from methane.

4N₂+3CH₄+6H₂0−>3CO₂+8NH₃

The equation illustrates that for each ton of nitrogen produced, 0.32 tons of C are released, and the 80.95 million tons of nitrogen utilized would represent 26 million tons of C. This is a small a small number in relative terms to the amounts released by combustion of coal (2427 million tons-EIA, 2001)

The economics of hydrogen from biomass has been addressed in the 2001 report by Spath et al.(2001). Their conclusion was that pyrolytic conversion of biomass offered the best economics due in part to the opportunity for co-product production and reduced capital costs. However, this assessment was based on using bio-oil for reforming and acknowledged uncertainty in pricing for co-products. Their analysis, at a 20% IRR, provided plant gate pricing of hydrogen from $9.79-$11.41/GJ. In the UT study, hydrogen production equipment represented 23% of the total capital equipment costs and utilized a $4/GJ expense for methane. This cost represented ˜50% of total expenses and ˜45% of before tax profits. If we assume that other operational costs remain the same, with the increased cost of natural gas, the inside plant cost of renewable hydrogen would no longer be 2.4-2.8 times the costs from methane, but is approaching 1.6-1.9 times. Since net profits were based on market price of nitrogen, then increases in natural gas prices will change total income in the model as well. For simplicity if we use $7/GJ, then total income would increase 1.75× and expenses related to renewable hydrogen would roughly equal ˜50% of before tax profits. Intra plant usage of renewable hydrogen (i.e. no storage or transport expense) becomes significantly more competitive at our current natural gas prices.

Another advantage comes from a review of traditional ammonia processing methods and how they compare to the ECOSS process. The UT study notes that due to unfavorable equilibrium conditions inherent in NH₃ conversion, only 20-30% of the hydrogen is converted in a single pass. From the section in this paper on Production Chemistry Calculations, we determined that the ECOSS process could only utilize 31.6% of the hydrogen as we were limited by the total amount of char produced and the target 10% nitrogen loading. This means that it possible that a single pass NH₃ converter could be used and the expense of separating and recycling unconverted hydrogen is eliminated. The 68.4% hydrogen is then available for sale or use by the power company/fertilizer partnership. This shows that the ECOSS process thus favors the inefficiencies of ammonia production and reduces costs inherent in trying to achieve high conversion rates of hydrogen

With increased biomass utilization for energy and increasing demands for food production, the requirements for fertilization will increase. The restoration and return of micronutrients could allow substantive increases in overall soil amendment applications and the potential needs for nitrogen may not be such a limiting factor as was considered in the UT study. From a global systems view, the combination of topsoil restoration, desert reclamation, and the associated increases in biomass growth, could allow the economics to be driven not by C capture but rather by value creation of increased soil/crop productivity.

This concept of biomass energy production with carbon utilization may open the door to millions of tons of CO₂ being removed from industrial emissions while utilizing captured C to restore valuable soil carbon content. This process simultaneously produces a zero emissions fuel that can be used to operate farm machinery and provide electricity for rural users, agricultural irrigation pumps, and rural industrial parks. Future developments from the global research community will produce a range of value added carbon containing co-products from biomass. With this development and future use of inventions like this, both the producers of carbon dioxide and agricultural community have the capability to become a significant part of the solution to the global rise in greenhouse gas emissions while building sustainable economic development programs for agricultural areas in the industrialized and economically developing societies.

As illustrated in FIG. 1, a stream of dry chipped, pelletized or cut biomass in sizes determined by the type of pryolyzer and biomass utilized 100 or carbonaceous material (renewable is best for carbon credit creation) is added to a pyrolysis, partial gasification, or thermolysis reactor 102. These reactors can be fast pyrolysis (and thus require smaller particles, or slow pyrolysis allowing larger particle size but having larger dimensions to effect the same throughput. These can be downdraft, updraft, cross draft, fluid bed or rotating kilns. These systems come in many commercial designs and are well known to those skilled in the art. The ability to maintain good temperature control and control char removal temperatures are important. An inert heat source 103 provides a heat source for bringing the reactor and can help assist in maintaining the operating temperature well within the exothermic range for the material. Since each biomass has differences, there is no set rule, but most well designed pyrolysis units can operate with little external heat after startup and with limited oxygen present. The char removal will functions best with an automated gate or star valve which discharges the char at optimal temperature ranges for the desired material. The higher temperature chars will release nutrients faster than lower temperature chars and according to the use and application of the fertilizer. However the range to insure maximum ammonia uptake will be less than 500C and above 350C. When dealing with any new biomass,. adsorption rates should be tested to establish performance criteria. This can be done by pyrolysis of the new material across a range of pyrolysis temperatures using a small furnace. Those skilled in the art can measure adsorption of ammonia on char using a sampling bag (tedlar bag), with a standard concentration of ammonia, char and using an analytical ammonia detector. As raw materials will vary, these tests can insure a baseline performance in scrubbing as well as in fertilizer performance. The inert heat source can be one of many gas, flue gas, nitrogen, carbon dioxide, but gas should be chosen to be compatible with the hydrogen production system. In the case of hydrogen steam reforming, heat recovered from the reformer 106 can be used and then the reformer will use the steam in transferred with the pyrolysis gases 105 for hydrogen production. As the char reaches the optimal temperature is it discharged into a nonoxidative chamber or transfer unit 108. The char can be allowed to cool slowly or can be lightly sprayed with water as it is discharged. The char is then ground 111 to 0.5.-3 mm. This will also vary according to the char materials. Chars made from grasses and lightweight biomass will crush easily to and create a larger percentage of smaller materials. These will agglomerate into bigger particles later, so they can still be used with suitable baghouses. There is evidence that larger particles work just as effectively as small particles. The reason for this is unknown.

The hydrogen production system, 106 while shown as steam reforming followed by CO shift, this system can be any unit that produces hydrogen suitable for continued processing into ammonia. The preferred system for maximum atmospheric carbon reduction is one which uses biomass or renewably derived fuels and derives its energy from a carbon neutral or negative source. Gases 109 containing primarily hydrogen and CO2 are separated using pressure swing adsorption 110 or other industry acceptable methods. The carbon dioxide 114 is greenhouse neutral at this point and can be release or used to replace 115 flue gas if there is no fossil fuel based carbon dioxide 123 available. When operated in this manner the energy derived has an even higher effective carbon negative accounting. Ammonia production 117 is shown as using the Haber process or other economically and industry accepted methods for ammonia production. At conditions needed to sequester 0.75 to 1.5 tons per hectare of carbon and provide sufficient charcoal to offer substantive plant response, a 10% nitrogen content is recommended. The resulting balance then points to 60-67% of the hydrogen produced will be available for sale. This lends to a configuration where 3 locations feed one which is the capture and fertilizer production center. The others produce hydrogen and or energy and charcoal which is sent then to one location where all of its hydrogen is utilized.

The ammonia produced 118 is then saturated with water by bubbling ammonia through water 119. This reaction produces heat and the water levels need to be monitored and automatically maintained. The gas phase hydrated ammonia 120 is then allowed to enter a chamber 121 with the charcoal. This saturation will be sufficiently complete in 3-10 seconds, according to particle size. The concentrations added to the char will be equal to 1.1-1.5 mole of NH₃ per mole of CO2 in the flue gas sought to capture as NH₄HCO₃. Char 112 is added at the so as to achieve the desire nitrogen ratio:

Charcoal Weight=(1−(TargetNitrogen % *79/14))*CapturedCO2moles*79

The amount of percentage SOx and NOx will be significantly lower than the number of moles of CO2 sought and at these temperatures, the production of ammonium sulfate and ammonium nitrate will reduce to mandatory emission levels and will become part of the ECOSS matrix increasing its value.

The saturate char 122 is then feed into a system, label here as a conversion cyclone, 124 where flue gases (with or without fly ash) 123 (at ambient temperature and pressure) can mix intimately and evenly also where the particles, once having completed the conversion of the adsorbed NH₃ to NH₄HCO₃, the particles are separated from particles which have not completed converted all of their NH3. The gases 125 now scrubbed of emissions and most of the fly ash are sent for final particulate scrubbing. The charcoal fertilizer granules are discharged 126 as they reach the desired density set by the nitrogen percent. Optionally, the charcoal fertilizer can be 126 mixed with other nutrients 131, trace minerals, and optionally coat 132 the granules with the above nutrient, or plaster, or polymers, or sulfur as known to those skilled in the arts, to give the particles longer and more precise 133 discharge rate, or a less expensive but effect soil amendment 134.

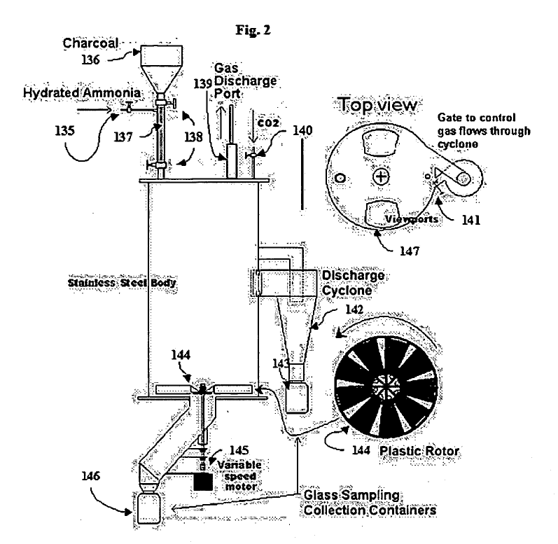

FIG. 2 illustrates the design of a simple conversion cyclone system to demonstrate the features described. Optomized charcoal 136 is gravity feed into a pipe between two valves 138 that allows the chamber 137 to be closed and a valve permits a gas stream of hydrated ammonia 135 to enter and saturate the material. The bottom valve of the two sealing the chamber is then opened allowing the saturated char to enter the 1.5 meter tall and a 50 cm diameter mechanically power cyclone. The stainless cylinder has a variable speed motor 145 driving a plastic fan/rotor which keeps the gas and particles held up in suspension. Two thirds of the way down is a discharge cyclone 142 with rotating gate 141 to control gas flows through the cyclone. The metered CO2 rich gas stream 140 enters the cyclone, and in practice would discharge through the bottom where a glass sampling container 146 was located. A second glass sampling container 143 was located under the discharge cyclone. A gas sampling and discharge port 139 was located at the top of the system. Plexiglass view ports 147 allowed the suspended particles to be viewed as they moved down toward the discharge cyclone.

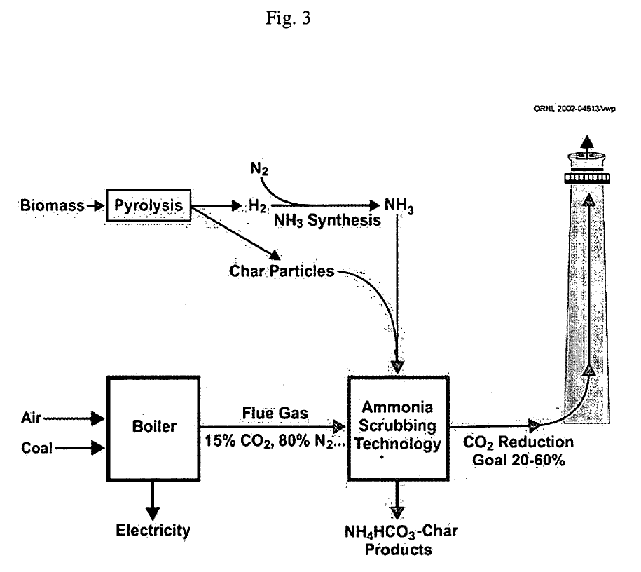

FIG. 3 illustrates conceptual design to remove CO2 emissions in industrial combustion facilities such as a coal-fired power plant by flexible combinations of the synergic processes as described in this invention: the pyrolysis of biomass and or carbonaceous materials and ammonia scrubbing. This CO2-removal technology produces valuable soil amendment fertilizer products such as NH4HCO3-char that can be sold and placed into soil and subsoil terrains through intelligent agricultural practice. Therefore, this invention could serve as a potentially profitable carbon-management technology for the fossil energy industries and contribute significantly to global carbon sequestration.

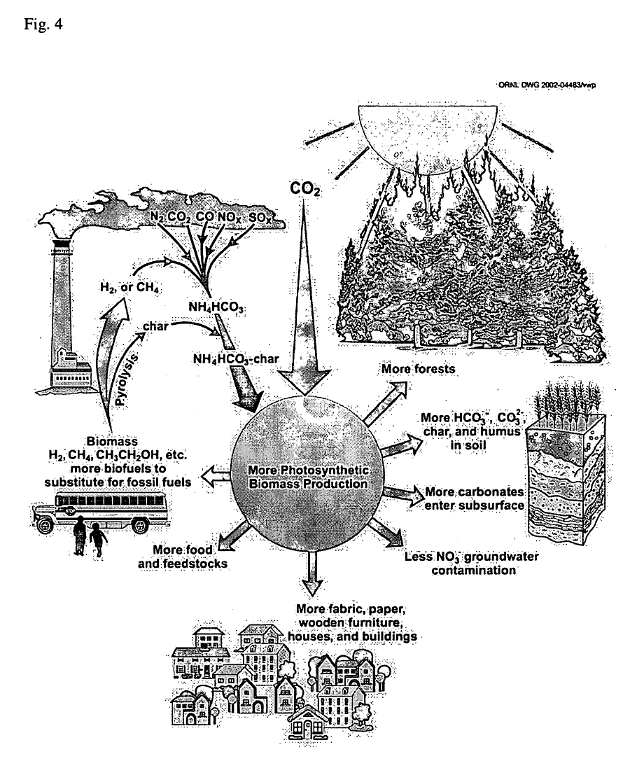

FIG. 4 illustrates the expected benefits from use of the invention that combines the biomass pyrolysis and NH3-CO2-solidifying NH4HCO3-production processes into a more-powerful technology for carbon management. This invention provides benefits of carbon sequestration and clean-air protection by converting biomass and industrial flue-gas CO2 and other emissions into mainly NH4HCO3-char products. The NH4HCO3-char products can be sold as a fertilizer and be placed into soil and subsoil earth layers as sequestered carbons, where they will also improve soil properties and enhance green-plant photosynthetic fixation of CO2 from the atmosphere thus increasing biomass productivity and economic benefits.

The pyrolysis of biomass materials and the steam reforming of the off gases and/or pyrolysis liquids produces significant amounts of hydrogen and a solid char product. Hydrogen, after separation, can be converted into ammonia using the industry standard Haber-Bosch process as the two reactions operate at the same temperature range. The ammonia when combined carbon dioxide (CO₂) form ammonium bicarbonate (NH₄HCO₃), with sulfur dioxide or nitrous oxide and a platinum and nickel catalyst will form HNO₃ and H₂SO₄. These which combined with NH₃ will form as an intermediate of NH₄ HCO₃and (NH₂)₂CO production process, to form additional fertilizer species, (NH₄)NO₃ and (NH₄)₂SO₄. The invention described here is the simultaneous production of hydrogen, its conversion into ammonia, a porous char, the combination of ammonia, and the flue gases of combustion or other high percentage sources of carbon dioxide and the porous char in order to deposition of nitrogen rich compounds in the pore structure of the carbonaceous material. The invention provides the use of this combined porous adsorbent char, enriched with nitrogen compounds, a slow release design coating from plaster, polymer and/or sulfer, for a slow release fertilizer/soil amendment with which is a novel method for sequestering large amounts of carbon from the atmosphere. Char makes a perfect media for storing significant quantities of compounds. The combination of nitrogen compounds created in and on the carbon can produce a slow release nitrogen fertilizer with many advantages over traditional ammonium nitrate, urea or liquid ammonia. One of these is that it is less reactive reducing the risk of it being used a compound for making explosives.

Since both the bicarbonate HCO₃ of NH₄HCO₃ and the elementary carbon (C) of the char materials are nondigestible to soil bacteria, they can be stored in soil and subsoil earth layers as sequestrated carbons for many years. Therefore, a combined NH₄HCO₃-char product can not only provide nutrients (such as NH₄⁺) for plant growth, but also has the potential to fully utilize the capacity of soil and subsoil earth layers to store both inorganic carbon (such as HCO₃ ) and organic elementary carbon (C). Urea (NH₂)₂CO can also be combined with the char materials to form a similar product. However, the urea production process generally costs some more energy and has less capacity to solidify CO₂ than the CO₂-solidifying NH₄HCO₃ production process (U.S. Pat. No. 6,447,437B 1). The char materials are also mixable with other nitrogen fertilizer species such as NH₄NO₃ and (NH₄)SO₄, but those mixtures would not have the benefits of providing bicarbonate (HCO₃ ) to soils. Therefore, the combined NH₄HCO₃-char product is preferred in realizing the maximal carbon-sequestration potential in soil and subsoil earth layers (FIGS. 1 and 2).

Furthermore, the combined NH₄HCO₃-char product has synergistic benefits. First, the char particles can be used as catalysts (providing more effective nucleation sites) to speed up the formation of solid NH₄HCO₃ particles in the CO₂-solidifying NH₄HCO₃ production process, thus enhancing the efficiency of the CO₂-solidifying technology. Second, the char materials are generally alkaline in pH because of the presence of certain mineral oxides in the ash product. The pH value of a typical char material is about 9.8. This alkaline material may not be favorable for use in alkaline soils such as those in the western United States while it is very suitable for use in acidic soils such as those in the eastern United States. However, use of NH₄HCO₃ can neutralize the alkali of the char materials. When the char materials are mixed with NH₄HCO₃ of equal weight, the pH of the product becomes much better (closer to neutral pH 7). As illustrated in Table 1, the pH value of the NH₄HCO₃-char mixture is 7.89, which is significantly lower (better) than that of the char material (pH 9.85). Therefore, this type of NH₄HCO₃-char combined fertilizer will be able to be used in alkaline soils, in addition to pH neutral and acidic soils. This type of NH₄HCO₃-char fertilizer can be produced either by the char particle-enhanced NH₃-CO₂-solidifying NH₄HCO₃ production process (FIG. 3) or by physically mixing NH₄HCO₃ with char materials. FIG. 4 presents photograph of the NH₄HCO₃-char fertilizer samples that were created by char particle-enhanced NH₃-CO₂-solidifying NH₄HCO₃ production process [marked as “treated char’] and by a physical mixing of NH₄HCO₃ and char [marked as “NH₄HCO₃-char mixture (50%/50% W)”]. Depending on the amount of NH₄HCO₃ deposited onto the char particles by char particle-enhanced NH₃-CO₂-solidifying NH₄HCO₃ production process, the treated char has a pH value of 8.76 in this particular sample. The pH of the product can be further improved by deposition more NH₄HCO₃ onto the char particles by the process.

When the NH₄HCO₃-char product is applied into soil, it can generate yet another synergistic benefit. For example, in the western parts of China and the United States where the soils contains significantly higher amount of alkaline earth minerals and where the soil pH value is generally above 8, when NH₄HCO₃ is used alone, its HCO₃ can neutralize certain alkaline earth minerals such as [Ca(OH)]⁺ and/or Ca⁺⁺ to form stable carbonated mineral products such as CaCO₃ that can serve as a permanent sequestration of the carbon. As more and more carbonated earth mineral products are formed when NH₄HCO₃ is used repeatedly as fertilizer for tens of years, some of the soils could gradually become hardened. This type of “soil hardening” has been noticed in some of soils in the western part of China where NH₄HCO₃ has been used as a fertilizer for over 30 years. It is also known that this type of soil “hardening” problem could be overcome by application of organic manure including humus. Char is another ideal organic material that can overcome the “soil hardening” problem because of its soft, porous, and absorbent properties. Therefore, co-use of NH₄HCO₃ and char materials together can allow continued formation of carbonated mineral products such as CaCO₃ and/or MgCO₃ to sequester maximal amount of carbons into the soil and subsoil terrains while still maintaining good soil properties for plant growth.

Another embodiment of the invention can be to also add other nutrients to the carbon. The material itself contains trace minerals needed for plant growth. Adding phosphorus, calcium and magnesium can augment performance and create a slow release micro nutrient delivery system.

Another embodiment of the invention can include the processing of the carbon to produce very large pore structures. The material can be used as an agent to capture watershed runoff of pesticides, and herbicides. By adding a deposition of various materials (example: gaseous iron oxide), the material can be used to capture such compounds as phosphorus from animal feedlots.

Another embodiment for the invention is to use standard industrial processes well known to those skilled in the arts, to use the hydrogen produced, combined with air and other free nitrogen present in the production process to create the ammonia that will be used as the nitrogen source material.

Based on market demands, these products can be further combined with other fertilizer species such as potassium, magnesium, ammonium sulfate, ammonium nitrate, and micro mineral nutrients such as iron and molybdenum to make more-nutrient-complete compound fertilizers.

To assist an appreciation by those of skill of the art for the scope of exemplary embodiments of the present invention, the Applicants have identified within the body of this technical specification certain publications relevant to the technical field of the present invention. Applicants have used an identifier of the format “Author(s)/Publication year” to provide a readily recognizable identifier for these references. A complete listing of the identified references is provided below in Table 3.

TABLE 3
References

Fakoussa RM, Hofrichter M (1999) Biotechnology and microbiology of coal
degradation. Appl Microbiol Biotechnol 52: 25-40
Shneour EA (1966) Oxidation of graphitic carbon in certain soils.
Science 151: 991-992
Lal, R., Kimble, J. M., Follett, R. F. and Stewart, B. A. 1998a. Soil Processes and
the Carbon Cycle. CRC Press LLC, MA USA, pp 609.
Hao, Y. L., Lal, R., Izaurralde, R. C., Ritchie, J. C., Owens, L. B. and Hothem, D.
L. 2001. Historic assessment of agricultural impacts on soil and soil organic
carbon erosion in an Ohio watershed. Soil Science 166: 116-126.
Vitousek, P. M. 1991. Can planted forests counteract increasing atmospheric
carbon dioxide? Journal of Environmental Quality 20: 348-354.
Haumaier L, Zech W (1995) Black carbon - possible source of highly aromatic
components of soil humic acids. Org Geo-chem 23: 191-196
Glaser B, Haumaier L, Guggenberger G, Zech W (1998) Black carbon in soils: the
use of benzenecarboxylic acids as specific markers. Org Geochem 29: 811-819
Nishio M, Okano S 1991 Stimulation of the growth of alfalfa and infection of roots with
indigenous vesicular-arbuscular mycorrhizal fungi by the application of charcoal. Bull.
Natl. Grassl. Res. Inst. 45, 61-71.
Asada, T. et al, Science of Bamboo Charcoal. Study on Carbonizing Temperature
of Bamboo Charcoal and Removal Capability of Harmful Gases Journal of
Health Science 2002, 48(6) 473-479
Matsui, T. et al, Preparation and Analysis of Carbonization Products from Sgi,
Cryptomra japonica D. Don) Wood. Nippon Kagakukaishi 2000; 1: 53-61
(Japanese)
Nishimaya, K. et al., Analysis of Chemical Structure of Wood Cjrcoal by X-ray
photoelectron spectroscopy 1998, Journal of Wood Science, 44, 56-61
Day, D., Activities web report of a 100 hour production run of hydrogen from
biomass in Blakely, GA, USA; 2002 http://www.eprida.com/hydro/
Gavin, D. G., Brubaker, L. B., and Lertzman, K. P. Holocene fire history of a
coastal temperate rain forest based on soil charcoal radiocarbon dates. In press
for Ecology: 2003
IPCC, “Climate change 2001: the scientific basis”, Intergovernmental Panel on
Climate Change, 2001 (see also at
http://www.grida.no/climate/ipcc_tar/wg1/index.htm.)
Walsh, Marie et al., Biomass Feedstock Availability in the United States: 1999
State Level Analysis, 1999 http://bioenergy.ornl.gov/resourcedata/index.html
Y. Yeboah, et al., Hydrogen from Biomass for Urban Transportation,
Proceedings of the 2002 US DOE Hydrogen Program Review; 2002
Day, Danny; Robert Evans, James Lee U.S. Patent Application, 2002
Yelverton, F. The use of activated carbon to inactivate agricultural chemical
spills, North Carolina Cooperative Extension Service, March, 1996,
http.//www.bae.ncsu.edu/bae/programs/extension/publicat/wqwm/ag442.html
Lee, J. W.; Li, R., A Novel Strategy for CO2 Sequestration and Clean Air
Protection, Proceedings of First National Conference, on Carbon Sequestration,
Washington, DC, May 1417, 2001.
http://www.netl.doe.gov/publications/proceedings/01/carbon_seq/p12.pdf
Lee, J. W.; Li, R, Method for Reducing CO2, CO, NOx, and SOx Emissions,
1998 Oak Ridge National Laboratory Invention Disclosure, ERID 0631; 2002
U.S. Pat. No. U.S. Pat. No. 6,447,437 B1.
Lee, J. W., and R. Li, Integration of Coal-Fired Energy Systems with CO2
Sequestration through NH4HCO3 Production, Energy Conversion Management
2003; 44: 1535-1546.
Schleppi P., Bucher-Wallin I., Siegwolf R., Saurer M., Muller N. & Bucher J. B.,
Simulation of increased nitrogen deposition to a montane forest ecosystem:
partitioning of the added N; Water Air Soil Pollution 1999; 116: 129-134
Glaser B., Lehmann J., Zech W. Ameliorating physical and chemical properties
of highly weathered soils in the tropics with charcoal - a review. Biology and
Fertility of Soils 2002; 35: 219-230.
Wardle, D. A. et al., The charcoal effect in Boreal forests: mechanisms and
ecological consequences, Oecologia 1998; Volume 115 Issue 3: 419-426
International Cooperation in Agriculture and Forestry, Application of Rice Hull
Char, Taiwan, 2002; Leaflet 03-01
http://www.agnet.org/library/article/pt2001004.html
Day, D., Activities web report of a 100 hour production run of hydrogen from
biomass in Blakely, GA, USA; 2002: http://www.eprida.com/hydro/
Pietikainen, Janna, Soil microbes in boreal forest humus after fire (thesis 1999)
http://ethesis.helsinki.fi/julkaisut/maa/mekol/vk/pietikainen/soilmicr.html
Runkel, R. O. H and Wilke, K, Chemical composition and properties of wood
heated at 140 C to 200 C in a closed system without free space. Part II Holz als
Roh und Werkstoff 1951; 9: 260-270 (Ger.)
Godsy, E. Michael, Impact of Human Activity on Groundwater Dynamics
(Proceedings of a symposium held during the Sixth IAHS Scientific Assembly at
Maastricht, The Netherlands, July 2001). IAHS Publication no. 269, 2001, pp.
303-309.
Li, E. Hagaman, C. Tsouris, and J. W. Lee, “Removal of carbon dioxide from
flue gas by ammonia carbonation in the gas phase,” Energy & Fuels 2003; 17:
69-74.
Asada, T. et al, Science of Bamboo Charcoal: Study of Carbonizing Temperature
of Bamboo Charcoal and Removal Capability of Harmful Gases, Journal of
Health Science 2002; 48(6): 473-479
Gaur, S Reed, T. B., Thermal Data for Natural and Synthetic Fuels. New York;
Marcel Dekker, 1998: 200-244
Czernik, Stefan, (2003) Personal correspondence and emails, National
Renewable Energy Laboratory, March
Oberstiener, et al., Biomass Energy, Carbon Removal and Permanent
Sequestration - A ‘Real Option’ for Managing Climate Risk, Report no. IR-02-
042, Laxenburg, Austria: International Institute for Applied Systems Analysis,
2002.
Glaser B., Lehmann J., Zech W., Ameliorating physical and chemical properties
of highly weathered soils in the tropics with charcoal - a review. Biology and
Fertility of Soils 2002; 35; 219-230.
International Cooperation in Agriculture and Forestry, Application of Rice Hull
Char, Taiwan, 2002; Leaflet 03-01
http://www.agnet.org/library/article/pt2001004.html
Hall, D. O., F. Rossillo-Calle, R. H. Williams and J. Woods,: Biomass for energy:
Supply prospects. In: Renewable Energy. Sources for Fuel and Electricity
[Johansson, T. B., H. Kelly, A. K. N. Reddy, and R. H. Williams (eds.)]. Island Press,
Washington, D.C., 1993: 593-652
Athon, et al., CO2 Sequestration from Coal Fired Power Plant Flue Gas, (a pre-
patent confidential design project study for co-author James Lee), University of
Tennessee, 2000 (see also
http://www.eprida.com/hydro/ecoss/background/CO2seqeconomics.pdf)
The Fertilizer Institute, World Fertilizer Use, 2003;
http://www.tfi.org/Statistics/worldfertuse.asp
Mann, M., Life Cycle Assessment of a Biomass Gasification Combined-Cycle
System, National Renewable Energy Laboratory Report 1997, United States
Mann, C., The Real Dirt on Rainforest Fertility, Science 2002; 297: 920-923
Hoshi, T. (web report of growth studies with charcoal amendments on green tea
yields) 2002 http://www.fb.u-tokai.ac.jp/WWW/hoshi/cha
Glaser, et.al, Potential of Pyrolyzed Organic Matter in Soil Amelioration, 12th
ISCO Conference, China, 2002; 3: 421
Nishio, M., Microbial Fertilizers in Japan, Bulletin by National Institute of Agro-
Environmental Sciences, Japan, 1999
Ogawa, M., Effect of charcoal on the root nodule and VA mycorrhizal formation
of soybean, Proceedings of the Third Inter-national Mycology Congress, Tokyo,
Ja-pan, 1983: 578
World Carbon Dioxide Emissions from the Consumption of Coal, 1992-2001
http://www.eia.doe.gov/emeu/iea/tableh4.html
Mosier, et.al, Closing the Global N2O budget: Nitrous Oxide Emissions through
the Agricultural Nitrogen Cycle, Nutrient Cycling and in Agro Ecosystems 1998,
52: 223-245
Kaiser et al, Nitrous Oxide Release from Arable Soil: Importance of N
Fertilization, Crops and Temporal Variation; Soil Biological Biochemistry 1998,
Germany; 30, no12: 1553-1563
Spath, et al, Update of Hydrogen from Biomass - Determination of the Delivered
Cost of Hydrogen, National Renewable Energy Laboratory, Milestone Report for
the U.S. Department of Energy's Hydrogen Program 2001, United States
Zackrisson, O. 1977. Influence of forest fires on the North Swedish boreal forest.
Oikos 29: 22-32.
De Laat, J., Bouanga, F. & Dore, M. 1985. Influence of microbiological activity
in granular activated carbon filters on the removal of organic compounds. The
Science of the Total Environment 47: 115-120.
Kim, D.-J., Miyahara, T. & Noike, T. 1997. Effect of C/N ratio on the
bioregeneration of biological activated carbon. Water Science and Technology
36: 239-249.
References
Fakoussa RM, Hofrichter M (1999) Biotechnology and microbiology of coal
degradation. Appl Microbiol Biotechnol 52: 25-40
Shneour EA (1966) Oxidation of graphitic carbon in certain soils.
Science 151: 991-992
Lal, R., Kimble, J. M., Follett, R. F. and Stewart, B. A. 1998a. Soil Processes and
the Carbon Cycle. CRC Press LLC, MA USA, pp 609.
Hao, Y. L., Lal, R., Izaurralde, R. C., Ritchie, J. C., Owens, L. B. and Hothem, D. L.
2001. Historic assessment of agricultural impacts on soil and soil organic
carbon erosion in an Ohio watershed. Soil Science 166: 116-126.
Vitousek, P. M. 1991. Can planted forests counteract increasing atmospheric
carbon dioxide? Journal of Environmental Quality 20: 348-354.
Haumaier L, Zech W (1995) Black carbon - possible source of highly aromatic
components of soil humic acids. Org Geo-chem 23: 191-196
Glaser B, Haumaier L, Guggenberger G, Zech W (1998) Black carbon in soils:
the use of benzenecarboxylic acids as specific markers. Org Geochem 29: 811-819
Nishio M, Okano S 1991 Stimulation of the growth of alfalfa and infection of roots
with indigenous vesicular-arbuscular mycorrhizal fungi by the application of
charcoal. Bull. Natl. Grassl. Res. Inst. 45, 61-71.
Asada, T. et al, Science of Bamboo Charcoal: Study on Carbonizing Temperature
of Bamboo Charcoal and Removal Capability of Harmful Gases, Journal of
Health Science 2002, 48(6) 473-479
Matsui, T. et al, Preparation and Analysis of Carbonization Products from Sgi,
Cryptomra japonica D. Don) Wood. Nippon Kagakukaishi 2000; 1: 53-61
(Japanese)
Nishimaya, K. et al., Analysis of Chemical Structure of Wood Cjrcoal by X-ray
photoelectron spectroscopy 1998, Journal of Wood Science, 44, 56-61
Day, D., Activities web report of a 100 hour production run of hydrogen from
biomass in Blakely, GA, USA; 2002 http://www.eprida.com/hydro/
Gavin, D. G., Brubaker, L. B., and Lertzman, K. P. Holocene fire history of a
coastal temperate rain forest based on soil charcoal radiocarbon dates. In press
for Ecology: 2003
IPCC, “Climate change 2001: the scientific basis”, Inter governmental Panel on
Climate Change, 2001 (see also at
http.//www.grida.no/climate/ipcc_tar/wg1/index.htm.)
Walsh, Marie et al., Biomass Feedstock Availability in the United States: 1999
State Level Analysis, 1999 http://bioenergy.ornl.gov/resourcedata/index.html
Y. Yeboah, et al., Hydrogen from Biomass for Urban Transportation,
Proceedings of the 2002 US DOE Hydrogen Program Review; 2002
Day, Danny; Robert Evans, James Lee U.S. Patent Application, 2002
Yelverton, F. The use of activated carbon to inactivate agricultural chemical
spills, North Carolina Cooperative Extension Service, March, 1996,
http://www.bae.ncsu.edu/bae/programs/extension/publicat/wqwm/ag442.html
Lee, J. W.; Li, R., A Novel Strategy for CO2 Sequestration and Clean Air
Protection, Proceedings of First National Conference on Carbon Sequestration,
Washington, DC, May 1417, 2001.
http://www.netl.doe.gov/publications/proceedings/01/carbon_seq/p12.pdf
Lee, J. W.; Li, R, Method for Reducing CO2, CO, NOx, and SOx Emissions,
1998 Oak Ridge National Laboratory Invention Disclosure, ERID 0631; 2002.
U.S. Pat. No. U.S. Pat. No. 6,447,437 B1.
Lee, J. W., and R. Li, Integration of Coal-Fired Energy Systems with CO2
Sequestration through NH4HCO3 Production, Energy Conversion Management
2003; 44: 1535-1546.
Schleppi P., Bucher-Wallin I., Siegwolf R., Saurer M., Muller N. & Bucher J. B.,
Simulation of increased nitrogen deposition to a montane forest ecosystem:
partitioning of the added N; Water Air Soil Pollution 1999; 116: 129-134
Glaser B., Lehmann J., Zech W., Ameliorating physical and chemical properties
of highly weathered soils in the tropics with charcoal - a review. Biology and
Fertility of Soils 2002; 35: 219-230.
Wardle, D. A. et al., The charcoal effect in Boreal forests: mechanisms and
ecological consequences, Oecologia 1998; Volume 115 Issue 3: 419-426
International Cooperation in Agriculture and Forestry, Application of Rice Hull
Char, Taiwan, 2002; Leaflet 03-01
http://www.agnet.org/library/article/pt2001004.html
Day, D., Activities web report of a 100 hour production run of hydrogen from
biomass in Blakely, GA, USA; 2002: http://www.eprida.com/hydro/
Pietikainen, Janna, Soil microbes in boreal forest humus after fire (thesis 1999)
http://ethesis.helsinki.fi/julkaisut/maa/mekol/vk/pietikainen/soilmicr.html
Runkel, R. O. H and Wilke, K, Chemical composition and properties of wood
heated at 140 C to 200 C in a closed system without free space. Part II Holz als
Roh und Werkstoff 1951; 9: 260-270 (Ger.)
Godsy, E. Michael, Impact of Human Activity on Groundwater Dynamics
(Proceedings of a symposium held during the Sixth IAHS Scientific Assembly at
Maastricht, The Netherlands, July 2001). IAHS Publication no. 269, 2001, pp.
303-309.
Li, E. Hagaman, C. Tsouris, and J. W. Lee, “Removal of carbon dioxide from
flue gas by ammonia carbonation in the gas phase,” Energy & Fuels 2003; 17:
69-74.
Asada, T. et al, Science of Bamboo Charcoal: Study of Carbonizing Temperature
of Bamboo Charcoal and Removal Capability of Harmful Gases, Journal of
Health Science 2002; 48(6): 473-479
Gaur, S Reed, T. B., Thermal Data for Natural and Synthetic Fuels. New York;
Marcel Dekker, 1998: 200-244
Czernik, Stefan, (2003) Personal correspondence and emails, National
Renewable Energy Laboratory, March
Oberstiener, et al., Biomass Energy, Carbon Removal and Permanent
Sequestration - A ‘Real Option’ for Managing Climate Risk, Report no. IR-02-
042, Laxenburg, Austria: International Institute for Applied Systems Analysis,
2002.
Glaser B., Lehmann J., Zech W., Ameliorating physical and chemical properties
of highly weathered soils in the tropics with charcoal - a review. Biology and
Fertility of Soils 2002; 35; 219-230.
International Cooperation in Agriculture and Forestry, Application of Rice Hull
Char, Taiwan, 2002; Leaflet 03-01
http://www.agnet.org/library/article/pt2001004.html
Hall, D. O., F. Rossillo-Calle, R. H. Williams and J. Woods,: Biomass for energy:
Supply prospects. In: Renewable Energy: Sources for Fuel and Electricity
[Johansson, T. B., H. Kelly, A. K. N. Reddy, and R. H. Williams (eds.)]. Island Press,
Washington, D.C., 1993: 593-652
Athon, et al., CO2 Sequestration from Coal Fired Power Plant Flue Gas, (a pre-
patent confidential design project study for co-author James Lee), University of
Tennessee, 2000 (see also
http://www.eprida.com/hydro/ecoss/background/CO2seqeconomics.pdf)
The Fertilizer Institute, World Fertilizer Use, 2003,
http://www.tfi.org/Statistics/worldfertuse.asp
Mann, M., Life Cycle Assessment of a Biomass Gasification Combined-Cycle
System, National Renewable Energy Laboratory Report 1997, United States
Mann, C., The Real Dirt on Rainforest Fertility, Science 2002; 297: 920-923
Hoshi, T. (web report of growth studies with charcoal amendments on green tea
yields) 2002 http://www.fb.u-tokai.ac.jp/WWW/hoshi/cha
Glaser, et. al, Potential of Pyrolyzed Organic Matter in Soil Amelioration, 12th
ISCO Conference, China, 2002; 3: 421
Nishio, M., Microbial Fertilizers in Japan, Bulletin by National Institute of Agro-
Environmental Sciences, Japan, 1999
Ogawa, M., Effect of charcoal on the root nodule and VA mycorrhizal formation
of soybean, Proceedings of the Third Inter-national Mycology Congress, Tokyo,
Ja-pan, 1983: 578
World Carbon Dioxide Emissions from the Consumption of Coal, 1992-2001
http://www.eia.doe.gov/emeu/iea/tableh4.html
Mosier, et. al, Closing the Global N2O budget: Nitrous Oxide Emissions through
the Agricultural Nitrogen Cycle, Nutrient Cycling and in Agro Ecosystems 1998,
52: 223-245
Kaiser et al, Nitrous Oxide Release from Arable Soil: Importance of N
Fertilization, Crops and Temporal Variation; Soil Biological Biochemistry 1998,
Germany; 30, no 12: 1553-1563
Spath, et al, Update of Hydrogen from Biomass - Determination of the Delivered
Cost of Hydrogen, National Renewable Energy Laboratory, Milestone Report for
the U.S. Department of Energy's Hydrogen Program 2001, United States
Zackrisson, O. 1977. Influence of forest fires on the North Swedish boreal forest.
Oikos 29: 22-32.
De Laat, J., Bouanga, F. & Dore, M. 1985. Influence of microbiological activity
in granular activated carbon filters on the removal of organic compounds. The
Science of the Total Environment 47: 115-120.
Kim, D.-J., Miyahara, T. & Noike, T. 1997. Effect of C/N ratio on the
bioregeneration of biological activated carbon. Water Science and Technology
36: 239-249.

1. A process for the pyrolysis of biomass and other carbonaceous materials releasing a pyrolytic gas high in volatile organic compounds and producing a solid carbon charcoal residue.

2. The process as in claim 1 where the temperature of the charcoal is managed to such that its does not exceed the temperature range between 350C where 500C for more than 2 minutes to maximize the formation of surface acids groups and preferential adsorption of bases which include ammonia.

3. The process as in claim 1 where the temperature of the resulting char particles exceeds 500C and is further heated or allowed to oxidized where the temperature remains above 600C for greater than 10 minutes to minimize the production of surface acids groups.

4. The process as in claims 1, 2 and 3 wherein the residue is further processed under various conditions, including but not limited to pressure, mechanical actions, heat, steam, oxygen, acid, carbon dioxide, addition of fertilizer components, such as potassium, magnesium, ammonium sulfate, ammonium nitrate, micro mineral nutrients such as iron molybdenum minerals, to optimize it for specific applications as an adsorbent and carrier of other materials.

5. The process as in claim 1, where in the gas is further processed using ceramic membranes to the convert and extract a purified hydrogen stream, or by using steam reforming or catalytically reforming of the pyrolysis or synthesis gas to produce a mixture gases including hydrogen, carbon monoxide, methane and carbon dioxide and where the carbon monoxide is produced it is converted through a high temperature or low temperature catalytic CO water shift reaction to hydrogen where hydrogen and carbon dioxide are the major components of the resulting gas.

6. The process as in claim 5, for separating the any unpurified hydrogen from carbon dioxide, nitrogen or other parasitic gases using standard industrial techniques, such as pressure swing adsorption, or membrane separation.

7. A process in accordance with claims 1, 5 and 6, where the combination of the hydrogen and air are used in standard industrially accepted techniques to produce ammonia or ammonium nitrate or other nitrogen compounds typical to those industry practices.

8. The process in accordance with claims 2 and 4, whereby all or a portion of the solid charcoal and ammonia, and water is injected or brought into intimate contact with the off-gas stream of a combustion or other process where such gas stream has a concentration of carbon dioxide, sulfur dioxide and nitrous oxide and where there is a desire to reduce the discharge of these materials into the atmosphere.

9. The process in accordance with claims 3 and 4, whereby all or a portion of the solid charcoal, and ammonia, and water is injected or brought into intimate contact with the off-gas stream of a combustion or other process where such gas stream has a concentration of carbon dioxide, sulfur dioxide and nitrous oxide and where there is a desire to reduce the discharge of these materials into the atmosphere.

10. The process in accordance with claims 8 and 9, where the charcoal residue and ammonia, water and off gases are held in intimate contact for at least 5 seconds.

11. The process as in claim 10 wherein the chemical reaction will allow ammonium bicarbonate (NH₄HCO₃) to be formed in the charcoal pores and onto its surface to produce NH₄HCO₃-charcoal fertilizers.

12. The process as in claim 10 wherein the chemical reaction also allows the formation of ammonium salts of nitrogen oxides and sulfur dioxide to be formed in contact with NH₄HCO₃-charcoal fertilizers.

13. The creation of a slow release sequestering soil amendment fertilizer to be combined with materials used by plant growth and depositing those materials inside the internal pore structures of the carbon residue making a solid powder and or granular material suitable for large scale agricultural applications.

14. A process in accordance with claims 1, 2, 3, 4, 5, 6, 7, 8, 9,10, 11, 12, or 13 where those compounds beneficial for plant growth are created or adsorbed onto the internal pore structure of the carbon residue creating a material which provides a slow release of the compounds.

15. A process in accordance with claim 13, and a coating is used to facilitate the handling, flow and added control of the rate of release of those compounds, and where such materials as are commonly used to create coatings such as but not limited to gypsum, plaster, sulfur, polymers as materials which dissolve or create a permeable layer when placed in the soil.

16. The use of a material as a soil amendment and fertilizer made with the processes described in claims 1 through 11 and creating those materials as described in claims 11, 12 or 13.
